(19) United States
(12) Patent Application Publication
(10) Pub. No.: US 2014/0166737 A1
(43) Pub. Date: Jun. 19, 2014

(54) Product Carton and Method for Forming Same

(71) Applicants: Douglas E. Mcleester, Bridgewater, NJ (US); Brian P. Byrne, Bridgewater, NJ (US)

(72) Inventors: Douglas E. Mcleester, Bridgewater, NJ (US); Brian P. Byrne, Bridgewater, NJ (US)

(21) Appl. No.: 14/232,189

(22) PCT Filed: Jul. 11, 2012
(86) PCT No.: PCT/US2012/046180

§ 371 Date: Jan. 10, 2014

Related U.S. Application Data
(60) Provisional application No. 61/506,841, filed on Jul. 12, 2011.

(30) Foreign Application Priority Data
Jun. 15, 2012 (FR) 1255618

(51) Int. Cl. B65D 5/32; B31B 1/26; B31B 1/88

(52) U.S. Cl. CPC B65D 5/32; B31B 1/88; B31B 1/26
USPC 229/122.21; 493/55; 493/243

(57) ABSTRACT

Described is a first panel for a carton comprising a first guide sheet having a first width (W1), a front panel coupled to the first guide sheet, a first side panel coupled to the front panel, and a top panel coupled to the front panel. Described is a carton blank for a carton comprising the first panel, and a second panel coupled to the first panel comprising a second guide sheet, a back panel coupled to the second guide sheet, a second side panel coupled to the back panel, and a bottom panel coupled to the back panel. The second panel is inverted relative to the first panel. Described is a method for forming a carton comprising producing the carton blank, printing content on the carton blank, removing the first guide sheet and the second guide sheet from the carton blank, and folding the carton blank along score lines to form the carton.

### CROSS REFERENCE TO RELATED APPLICATIONS

The present application is a U.S. National Phase Application pursuant to 35 U.S.C. §371 of International Application No. PCT/US2012/046180 filed Jul. 11, 2012, which claims priority to U.S. Provisional Patent Application No. 61/506,841 filed Jul. 12, 2011 and French Patent No. 1255618 filed Jun. 15, 2012. The entire disclosure contents of these applications are herewith incorporated by reference into the present application.

### FIELD OF INVENTION

A conventional product carton is typically constructed by using pre printed, die-cut and scored sheets which are fed through a large format printer (e.g., XEROX iGen4 with inline automated packaging). A blank formed in each sheet is punched out, folded and adhered to itself to form a carton.

### BACKGROUND

A conventional carton production process is time consuming, and minimum quantities typically greatly exceed actual need, which may result in waste and unnecessary costs.

Thus, there is a need for an improved product carton and a method for making the same. For example, a product carton which can be produced by an on-demand method in predetermined quantifies would be beneficial.

### SUMMARY

In an exemplary embodiment, a first panel for a carton according to the present invention comprises a first guide sheet having a first width, a front panel coupled to the first guide sheet, a first side panel coupled to the front panel, and a top panel coupled to the front panel. The first width is substantially equal to 8.5 inches. The first guide sheet is coupled to the front panel via a perforated cut line.

In an exemplary embodiment, the first panel further comprises a first glue panel coupled to the first side panel.

In an exemplary embodiment, the first panel further comprises a first tab coupled to the first side panel, a second tab coupled to the first side panel, and a third tab coupled to the top panel.

In an exemplary embodiment, a carton blank according to the present invention comprises a first panel as described herein and a second panel coupled to the first panel. The second panel comprises a second guide sheet, a back panel coupled to the second guide sheet, a second side panel coupled to the back panel, and a bottom panel coupled to the back panel. The second panel is inverted relative to the first panel.

In an exemplary embodiment, the second guide sheet has a second width substantially equal to 8.5 inches. The carton blank has a length substantially equal to 11 inches. The second guide sheet is coupled to the back panel via a perforated cut line.

In an exemplary embodiment, the second panel further comprises a second glue panel coupled to the second side panel.

In an exemplary embodiment, the second panel further comprises a fourth tab coupled to the second side panel, a fifth tab coupled to the second side panel, and

a sixth tab coupled to the bottom panel.

In an exemplary embodiment, the first glue panel is adhered to an interior surface of the second side panel and the second glue panel is adhered to an interior surface of the first side panel.

In an exemplary embodiment, when folded, the third tab engages the first tab and the fifth tab, and the sixth tab engages the third tab and the fourth tab.

In an exemplary embodiment, a method for forming a carton according to the present invention comprises producing a carton blank as described herein, printing content on the carton blank, removing the first guide sheet and the second guide sheet from the carton blank, and folding the carton blank along score lines to form the carton.

In an exemplary embodiment, the method for forming a carton further comprises folding the third tab to engage the first tab and the fifth tab, and folding the sixth tab to engage the third tab and the fourth tab.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an exemplary embodiment of two exemplary panels utilized to form a carton according to the present invention,

FIG. 2 shows an exemplary embodiment of two exemplary panels utilized to form a carton according to the present invention, and

FIG. 3 shows an exemplary embodiment two exemplary panels coupled together and utilized to form a carton according to the present invention.

Corresponding parts are marked with the same reference symbols in all figures.

### DETAILED DESCRIPTION

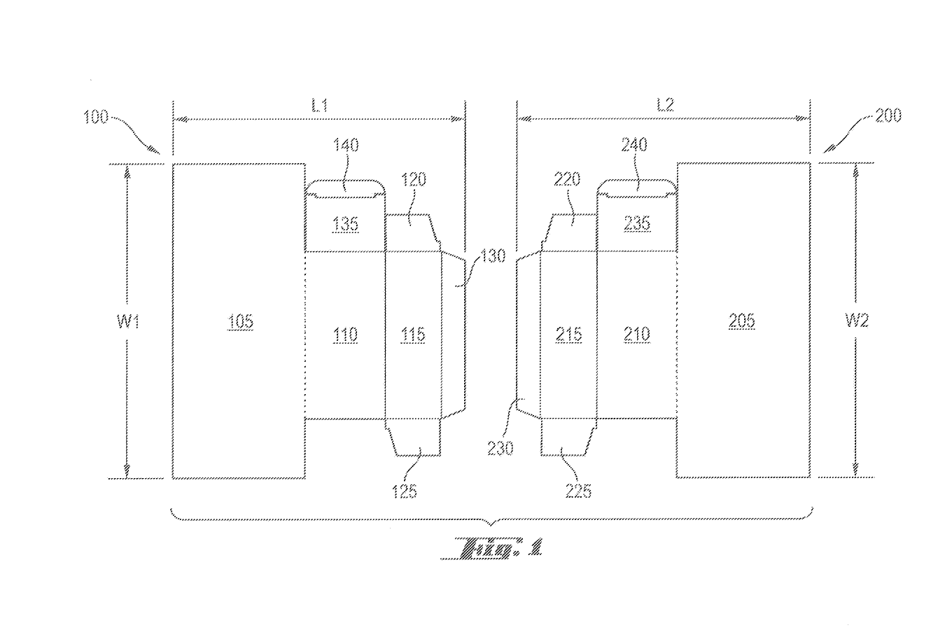

FIG. 1 shows an exemplary embodiment of two exemplary panels utilized to form a carton according to the present invention. In an exemplary embodiment, the carton may be utilized to contain a pharmaceutical or other health-care related product. However, those of skill in the art will understand that any product may be contained in the carton.

In an exemplary embodiment, a first panel 100 has a length L1 and a width W1. In an exemplary embodiment, the length L1 is less than 11 inches and the width W1 is about 8.5 inches. Those of skill in the art will understand that the length L1 and the width W1 may vary depending upon, for example, a size of the carton, a size of the printer being utilized to print the carton, etc.

In an exemplary embodiment, the first panel 100 includes a first guide sheet 105 having a width substantially equal to the width W1 of the first panel 100. In an exemplary embodiment, the width of the first guide sheet 105 is substantially equivalent to a size of paper or other stock which may be fed through a printer being used to print content (e.g., logos, tradenames, text, images, etc.) on the carton.

In an exemplary embodiment, a front panel 110 is coupled to the first guide sheet 105 via a perforated cut line. When printed, at least one side of the front panel 110 may contain the content.

The front panel 110 is coupled to a first side panel 115 via a score line. When printed, at least one side of the first side panel 115 may contain the content. The first side panel 115 is coupled to first and second tabs 120, 125 via score lines and a first glue panel 130 via a score line.

The front panel 110 is coupled to a top panel 135 via a score line, and the top panel 135 is coupled to a third tab 140 via a score line. When printed, at least one side of the top panel 135 may contain the content.

Those of skill in the art will understand that the first panel 100 may be formed by cutting or punching and scoring an original material to have the various panels and tabs noted above.

In an exemplary embodiment, a second panel 200 has a length L2 and a width W2. In an exemplary embodiment, the length L2 is less than 11 inches and the width W2 is about 8.5 inches. Those of skill in the art will understand that the length L2 and the width W2 may vary depending upon, for example, a size of the carton, a size of the printer being utilized to print the carton, etc.

In an exemplary embodiment, the second panel 200 includes a second guide sheet 205 having a width substantially equal to the width W2 of the second panel 200. In an exemplary embodiment, the width of the second guide sheet 205 is substantially equivalent to a size of paper or other stock which may be fed through a printer being used to print content (e.g., logos, tradenames, text, images, etc.) on the carton.

In an exemplary embodiment, a back panel 210 is coupled to the second guide sheet 205 via a perforated cut line. When printed, at least one side of the back panel 210 may contain the content.

The back panel 210 is coupled to a second side panel 215 via a score line. When printed, at least one side of the second side panel 215 may contain the content. The second side panel 215 is coupled to fourth and fifth tabs 220, 225 via score lines and a second glue panel 230 via a score line.

The second panel 210 is coupled to a bottom panel 235 via a score line, and the bottom panel 235 is coupled to a sixth tab 240 via a score line. When printed, at least one side of the bottom panel 235 may contain the content.

Those of skill in the art will understand that the second panel 200 may be formed by cutting or punching and scoring an original material to have the various panels and tabs noted above.

In the exemplary embodiment shown in FIG. 1, exterior (outwardly-facing) surfaces of the first and second panels 100, 200 are shown. Interior surfaces, thus, are facing into the page.

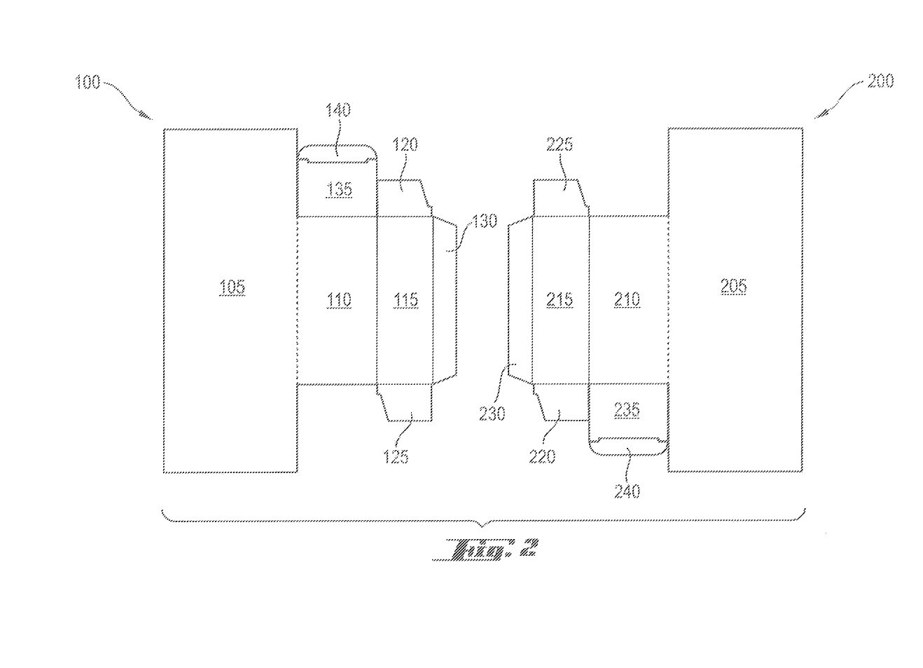

FIG. 2 shows an exemplary embodiment of two exemplary panels utilized to form a carton according to the present invention. Prior to printing, the first and second panels 100, 200 are inverted prior to being joined. For example, as shown in FIG. 2, the second panel 200 is rotated 180 degrees relative to a horizontal axis, such that the top and bottom panels 135, 235 are facing opposite directions. Thus, in the exemplary embodiment in FIG. 2, the exterior surface of the first panel 100 is shown with the interior surface of the second panel 200.

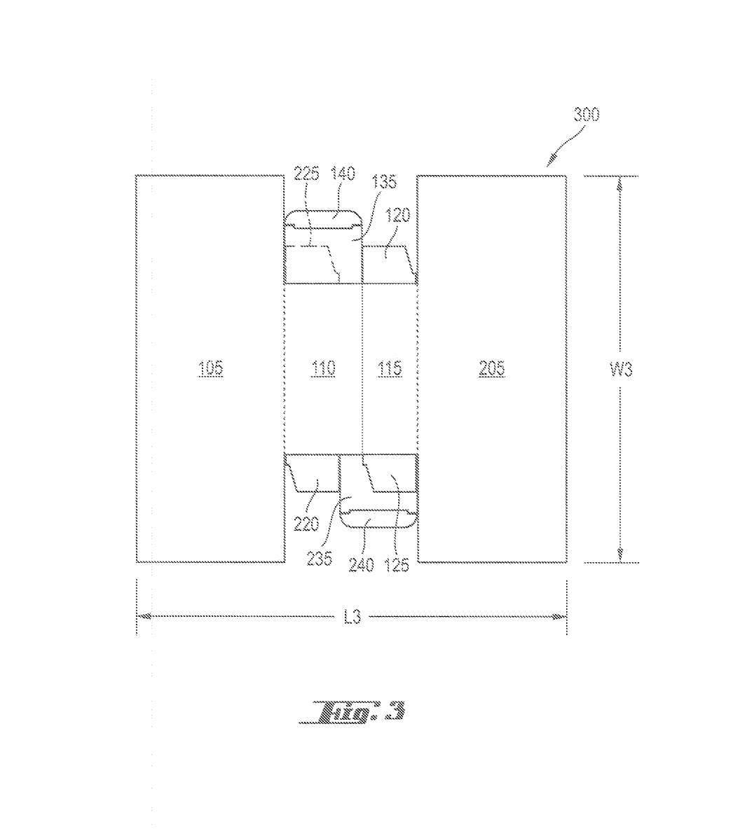

FIG. 3 shows an exemplary embodiment of two exemplary panels coupled together and utilized to form a carton according to the present invention. After inversion as shown in FIG. 2 and prior to printing, the first and second panels 100, 200 are joined via the first and second glue panels 130, 230 to form a carton blank. The first glue panel 130 may be adhered the interior surface of the back panel 210, and the second glue panel 230 may be adhered to the interior surface of the front panel 110, resulting in the configuration shown in FIG. 3 having a width W3 substantially equal to the widths W1 and W2, and a length L3 greater than L1 or L2. In an exemplary embodiment, the length L3 is substantially equal to 11 inches. Those of skill in the art will understand that the length L3 may be substantially equivalent to any other size printing material, e.g., A4, legal, etc.

After the first and second panels 100, 200 are joined, the carton blank 300 may be inserted into a printer. For example, the carton blank 300 may be duplex printed using a standard printer (e.g., XEROX 1000) configured for thick stock media. The first and second guide sheets 105, 205 may facilitate printing by allowing the carton blank 300 to be inserted into a sheet feeder on the printer.

After printing, the first and second guide sheets 105, 205 are removed from the carton blank 300 via the respective perforated cut lines. To form a carton 400, the front panel 110, the first and second side panels 115, 215 and the back panel 210 are folded to create a box-like configuration. The top panel 135, the first tab 120 and the fifth tab 225 are folded, and the third tab 140 engages the first tab 120 and the fifth tab 225. The bottom panel 235, the third tab 125 and the fourth tab 220 are folded, and the sixth tab 240 engages the third tab 125 and the fourth tab 220.

In an exemplary method of forming a carton according to the present invention, the first and second panels 100, 200 are created. The first and/or second panel 100, 200 is then inverted relative to the other panel. The first and second panels 100, 200 are then joined via the first and second glue panels 130, 230 to create the carton blank 300. The carton blank 300 is inserted into a printer. The first and second guide sheets 105, 205 are separated from the carton blank 300, and the carton blank 300 is folded via the score lines into the carton 400.

Those of skill in the art will understand that modifications (additions and/or removals) of various components of the apparatuses, methods and/or systems and embodiments described herein may be made without departing from the full scope and spirit of the present invention, which encompass such modifications and any and all equivalents thereof.

1-15. (canceled)

16. A first panel for a carton comprising:
a first guide sheet having a first width (W1);
a front panel coupled to the first guide sheet;
a first side panel coupled to the front panel; and
a top panel coupled to the front panel.

17. The first panel according to claim 16, wherein the first width (W1) is substantially equal to 8.5 inches.

18. The first panel according to claim 16, wherein the first guide sheet is coupled to the front panel via a perforated cut line.

19. The first panel according to claim 16, further comprising:
a first glue panel coupled to the first side panel.

20. The first panel according to claim 16, further comprising:
a first tab coupled to the first side panel;
a second tab coupled to the first side panel; and
a third tab coupled to the top panel.

21. A carton blank for a carton comprising:
a first panel according to claim 16; and
a second panel coupled to the first panel, the second panel comprising:
a second guide sheet;
a back panel coupled to the second guide sheet;
a second side panel coupled to the back panel; and
a bottom panel coupled to the back panel,
wherein the second panel is inverted relative to the first panel.

22. The carton blank according to claim 21, wherein the second guide sheet has a second width (W2) substantially equal to 8.5 inches.

23. The carton blank according to claim 21, wherein the carton blank has a length (L3) substantially equal to 11 inches.

24. The carton blank according to claim 21, wherein the second guide sheet is coupled to the back panel via a perforated cut line.

25. The carton blank according to claim 21, wherein the second panel further comprises:
a second glue panel coupled to the second side panel.

26. The carton blank according to claim 21, wherein the second panel further comprises:
a fourth tab coupled to the second side panel;
a fifth tab coupled to the second side panel; and
a sixth tab coupled to the bottom panel.

27. The carton blank according to claim 19, wherein the first glue panel is adhered to an interior surface of the second side panel and the second glue panel is adhered to an interior surface of the first side panel.

28. The carton blank according to claim 20, wherein, when folded, the third tab engages the first tab and the fifth tab), and the sixth tab (240) engages the third tab and the fourth tab.

29. A method for forming a carton comprising:
producing a carton blank according to claim 21;
printing content on the carton blank;
removing the first guide sheet and the second guide sheet from the carton blank; and
folding the carton blank along score lines to form the carton.

30. The method for forming a carton further comprising:
folding the third tab to engage the first tab and the fifth tab; and
folding the sixth tab to engage the third tab and the fourth tab.
